(19) United States
(12) Patent Application Publication
(10) Pub. No.: US 2009/0323104 A1
(43) Pub. Date: Dec. 31, 2009

(54) IMAGE FORMING APPARATUS AND IMAGE FORMING METHOD

(75) Inventor: Yoshikatsu Kamisuwa, Tokyo (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/477,311

(22) Filed: Jun. 3, 2009

Related U.S. Application Data
(60) Provisional application No. 61/076,273, filed on Jun. 27, 2008.

(51) Int. Cl. G06F 15/00

(52) U.S. Cl. 358/1.15

(57) ABSTRACT

An image forming apparatus includes a state determination unit configured to determine a state of a machine body, an input determination unit configured to receive an operation of a user, and a content delivery unit configured to perform content delivery using a transmission system of terrestrial digital broadcasting based on a request signal from the state determination unit or the input determination unit.

### CROSS-REFERENCE TO RELATED APPLICATION

This application is based upon and claims the benefit of U.S. Provisional Application No. 61/076,273, filed Jun. 27, 2008.

### TECHNICAL FIELD

The present invention relates to a technique for providing guidance information to a user or a serviceman in plain form at the time of occurrence of an event, such as the time of trouble processing, in an image forming apparatus.

### BACKGROUND

As a method of providing a trouble processing procedure to a user or a serviceman when a trouble occurs in an image forming apparatus, a technique disclosed in JP-A-11-231729 is known.

In the disclosed technique, the processing procedure corresponding to the occurring trouble is sequentially displayed in the form of text and images on a control panel as a display section.

### SUMMARY

According to a first aspect of the invention, an image forming apparatus includes a state determination unit configured to determine a state of a machine body, an input determination unit configured to receive an operation of a user, and a content delivery unit configured to perform content delivery using a transmission system of terrestrial digital broadcasting based on a request signal from the state determination unit or the input determination unit.

According to a second aspect of the invention, an image forming method includes determining a state of a machine body by a state determination unit, receiving an operation of a user by an input determination unit, and performing content delivery using a transmission system of terrestrial digital broadcasting by a content delivery unit based on a request signal from the state determination unit or the input determination unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a copy function structure of an MFP.

FIG. 2 is an outer appearance view of an operation panel 301 provided in the MFP.

FIG. 3 is a view showing trouble content and a processing procedure displayed on a control panel.

FIG. 4 is a block diagram showing a function unit relating to content delivery by one-seg broadcasting.

FIG. 5 is a flowchart showing a rough procedure of delivering guidance information.

FIG. 6 is a view showing an example of delivered content.

FIG. 7 is a flowchart showing a rough procedure of delivering guidance information according to a second embodiment.

FIG. 8 is a flowchart showing a rough procedure of delivering guidance information according to a third embodiment.

### DETAILED DESCRIPTION

### First Embodiment

Hereinafter, a first embodiment of the invention will be described while an image processing apparatus (MFP: Multi Function Peripheral) 201 is used as an example.

The MFP 201 is a digital compound machine for totally using various functions of office equipments, such as an image reception function by FAX, an image reception function by E-mail, and a print image reception function by network, in addition to scanning, reading and copying an image at a specified resolution and sheet size.

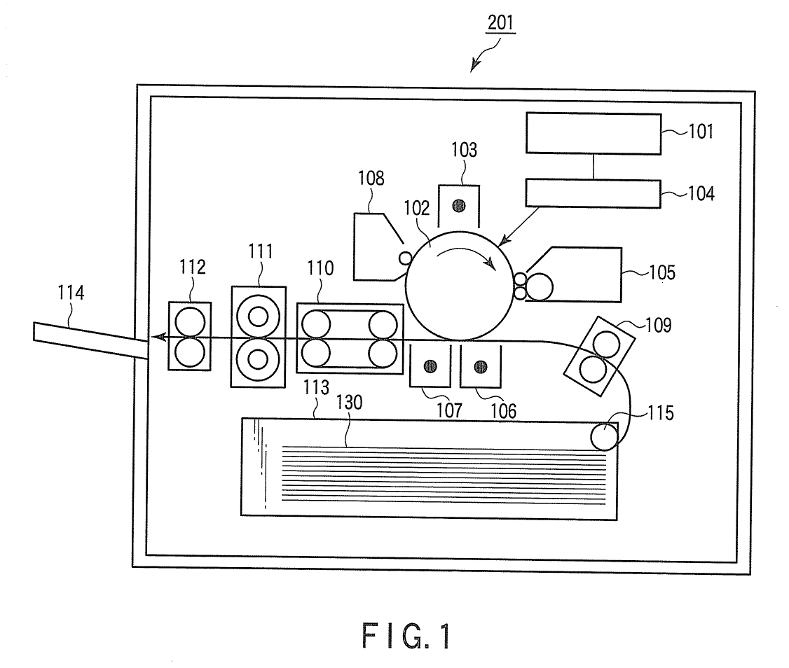

FIG. 1 is a block diagram showing a copy function structure of the MFP 201.

The MFP 201 includes a control section 101, a photoconductive drum 102, a charger 103, a scanning exposure section 104, a developing unit 105, a transfer charger 106, a peeling charger 107, a cleaner 108, a sheet feed section 109, a sheet conveying section 110, a fixing unit 111, a paper ejection section 112 and a storage tray 114.

The photoconductive drum 102 rotates in a sub-scanning direction (peripheral direction of the photoconductive drum 102). The charger 103 is disposed in the vicinity of the periphery of the photoconductive drum 102. The charger 103 uniformly charges the surface of the photoconductive drum 102. The scanning exposure section 104 turns on and off light emission according to an image signal while scanning a semiconductor laser in the scanning exposure section 104. The laser beam emitted from the semiconductor laser becomes a beam scanning in a main scanning direction (rotation axis direction of the photoconductive drum 102) by a deflector such as a polygon mirror. The laser beam is irradiated onto the photoconductive drum 102 by an optical system such as a lens. When the laser beam is irradiated to the charged photoconductive drum 102, the electric potential of the irradiated part is lowered and an electrostatic latent image is formed.

The developing unit 105 applies a developer to the photoconductive drum 102 to form a toner image on the photoconductive drum 102. On the other hand, a sheet tray 113 is provided at the bottom of the MFP 201. A sheet feed roller 115 separates a sheet 130 in the sheet tray 113 one by one and sends it to the sheet feed section 109. The sheet feed section 109 feeds the sheet 130 to the transfer position of the photoconductive drum 102. The transfer charger 106 transfers the toner image to the fed sheet 130. The peeling charger 107 peels the sheet 130 from the photoconductive drum 102.

The sheet 130 on which the toner image was transferred is conveyed by the sheet conveying section 110. The fixing unit 111 fixes the toner image to the sheet 130. The paper ejection section 112 ejects the sheet 130 on which the image was printed to the storage tray 114.

After the transfer of the toner image to the sheet 130 is ended, the remaining toner on the photoconductive drum 102 is removed by the cleaner 108. The photoconductive drum 102 is returned to the initial state, and is placed in standby state for next image formation.

The above process operation is repeated so that the image forming operation is continuously performed.

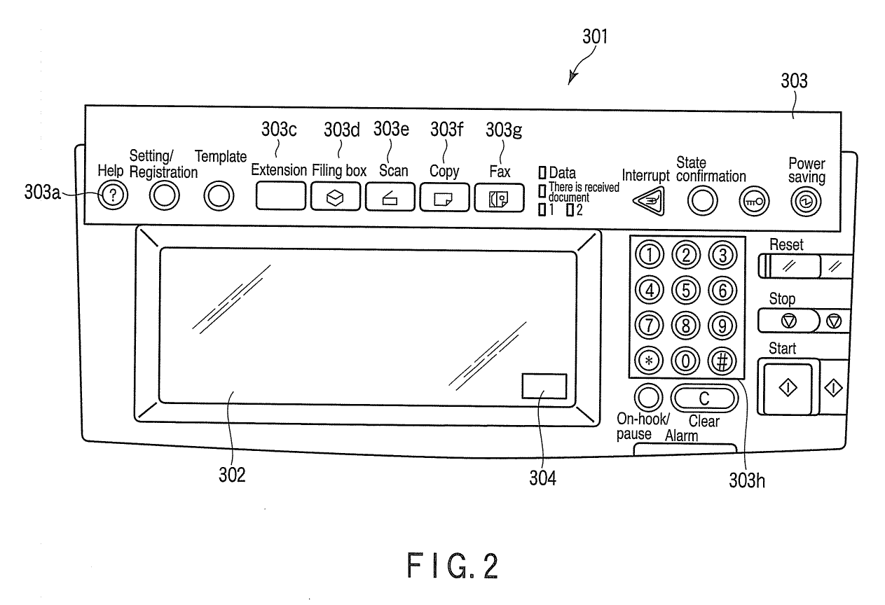

FIG. 2 is an outer appearance view of an operation panel 301 provided in the MFP 201.

The user performs setting and confirmation of the MFP 201 through this operation panel 301.

The operation panel 301 includes a display section 302 and an operation input section 303.

The display section 302 includes a touch panel, and displays a state of the MFP 201, an operation procedure, various instructions to the user and the like.

The operation input section 303 includes various operation buttons for operating the MFP 201.

A help button 303a, a function enhancement (extension) button 303c, a filing box button 303d, a scan button 303e, a copy button 303f, a fax button 303g and the like are disposed as keys for selecting functions and for calling up a set screen. In addition, a numeric keypad 303h and the like for inputting set values and confirming information are also disposed.

The functions of main buttons among these operation buttons will be described.

The help button 303a is used to enquire what operation is to be performed next. The extension button 303c is operated when the expanded function is used. The filing box button 303d is used when stored image data is extracted. The scan button 303e is used when the scan function is used. The copy button 303f is used when the copy function is used. The fax button 303g is used when the fax function is used. The numeric keypad 303h is used when a numeral is inputted.

Besides, an area 304 representing “shift to next procedure” is displayed on the display section 302. This function will be described later in detail.

Next, the outline of the operation of the image forming apparatus of the invention will be described.

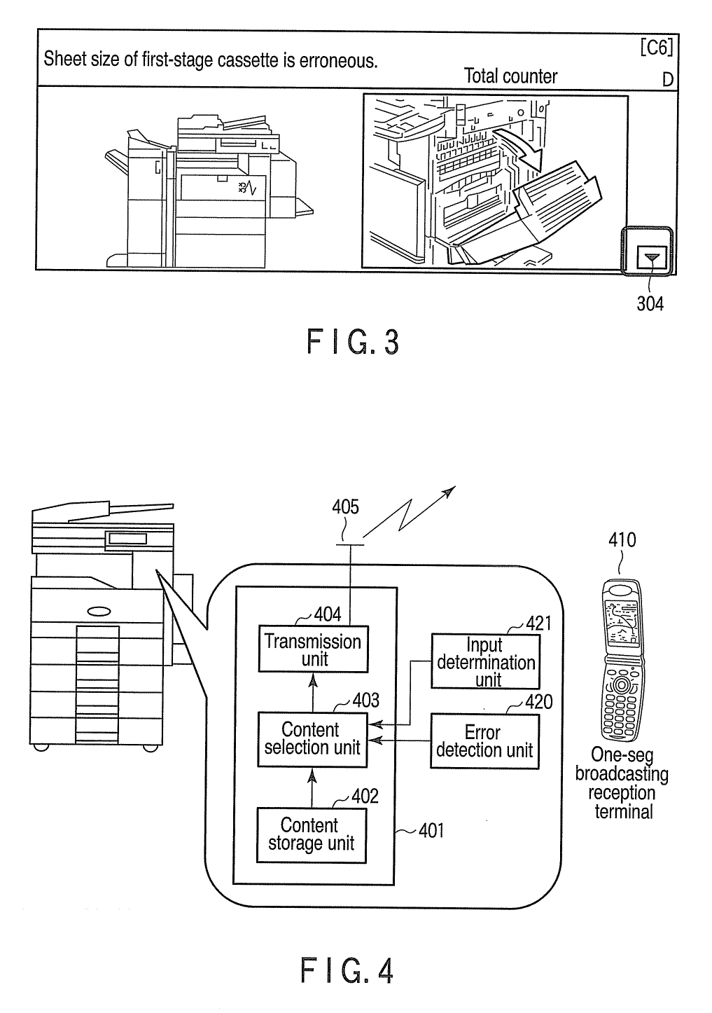

When a trouble such as a paper jam or toner depletion occurs in the MFP 201, a trouble detection unit such as a well-known sensor disposed in the inside of the MFP 201 detects the state. The trouble detection unit displays a text and an image representing the content of the trouble and a processing procedure as shown in FIG. 3 on the display section 302 of the control panel 301 of the MFP 201.

At the same time as this display, by an after-described content delivery method, the guidance using motion picture, voice and text of trouble processing procedure and replacement part information is transmitted by radio wave to a receiver or the like carried by a user or a serviceman.

The user or the serviceman can perform the trouble processing in accordance with the guidance using the motion picture, voice and text received by the carried receiver in addition to the display of the control panel 301. Further, when a more detailed guidance is required or a next processing procedure is required, the user or the serviceman depresses the help button 303a of the control panel 301 or the area 304 (FIG. 3) representing “shift to next procedure” in the display section 302 used also as the input section, and receives a new guidance.

Next, the content delivery method will be described.

With respect to the transmission by radio wave, in Japan, the practical service of one-segment broadcasting (hereinafter referred to as one-seg broadcasting) is started as terrestrial digital broadcasting from 2006. The one-seg broadcasting uses one carrier among thirteen carriers in OFDM (Orthogonal Frequency Division Multiplex) modulation which is the broadcasting system of the terrestrial digital broadcasting, and is put into practice mainly for a portable broadcasting reception terminal. As the portable reception terminal of the one-seg broadcasting, a cellular phone having a built-in reception function or a receiving apparatus for a note size PC (Personal Computer) is already introduced commercially.

With respect to the one-seg broadcasting, in Japan, it is admitted that local broadcast content for a limited area is transmitted by the same radio wave system as the terrestrial digital broadcasting. Further, according to the Radio Law of Japan, the license of a radio station is not necessary for a weak radio wave lower than a certain radio field intensity. Accordingly, when the use range is limited to a range of about several meters in diameter such as the periphery of the MFP 201 in an office, the license is not required and information can be delivered to a commonly diffused one-seg broadcasting receiver.

Here, as a merit obtained by using the one-seg broadcasting, it can be mentioned that the user is not required to have a special receiver for receiving the guidance.

As a method of delivering information, in addition to the one-seg broadcasting, it is conceivable that a wireless LAN (Local Area Network) is used and the information is received by a PC terminal. However, when the wireless LAN is used, the network environment of the user is used. Thus, for example, when the PC owned by the serviceman is connected to the network of the user by the wireless LAN, there is a possibility that a problem occurs in security. When the one-seg broadcasting is used, such a problem does not occur.

Incidentally, the “weak radio wave” of the embodiment of the invention means a radio wave having such a radio field intensity that the radio wave can be used in a limited range of about several meters in diameter, or a radio wave having such a radio field intensity that a license is not required.

FIG. 4 is a block diagram showing function units relating to the content delivery by the one-seg broadcasting.

The MFP 201 includes a content delivery unit 401, an error detection unit 420, and an input determination unit 421. The content delivery unit 401 includes a content storage unit 402, a content selection unit 403, a transmission unit 404 and a transmission antenna 405.

The content storage unit 402 stores motion pictures, voice and text information as content such as guidance of trouble processing procedure. The error detection unit 420 determines the state of the MFP 201. The input determination unit 421 receives the operation of the user from the control panel 301. The content selection unit 403 selects corresponding content from the content storage unit (not shown) based on an error notification signal from the error detection unit 420 or a guidance request from the control panel 301, and repeatedly outputs the content as a video signal for a specified time. The transmission unit 404 performs the OFDM modulation or frequency conversion on the video signal, and converts it into a broadcast wave of the terrestrial digital broadcasting.

The content transmitted from the content delivery unit 401 through the transmission antenna 405 is received by a one-seg broadcasting reception terminal 410. The user or the serviceman monitors the image of the one-seg broadcasting reception terminal 410 and acquires required guidance information.

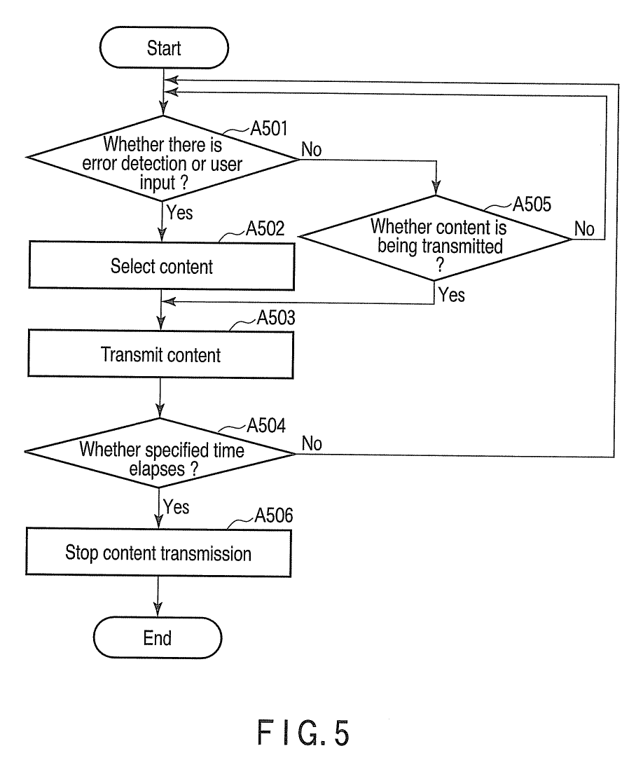

Next, the processing operation of the content delivery unit 401 will be described. FIG. 5 is a flowchart showing a rough procedure of delivering the guidance information.

At Act A501, when the occurrence of an error or the depression of the help button 303a by the user is detected (Yes at Act A501), at Act A502, the content selection unit 403 selects the corresponding content from the content stored in the content storage unit 402, converts it into a video signal and outputs it repeatedly.

At Act A503, the transmission unit 404 converts the video signal into the broadcast wave of the terrestrial digital broadcasting, and delivers the content from the transmission antenna 405. A time elapsed since the start of the delivery is measured so that the delivered content is repeatedly delivered for a sufficient time in which the user or the serviceman can finish the trouble processing. When the specified time (for example, 10 minutes) does not elapse since the start of the delivery (No at Act A504), return is made again to Act A501 as a state of waiting for error detection or user input.

When there is no new input from the user or the serviceman (No at Act A501) because, for example, the processing operation is being performed in accordance with the content, it is confirmed at Act A505 whether the content is being transmitted. When it is being transmitted (Yes at Act A505), the transmission of the content is continued at Act A503. Until the specified time elapses (No at Act A504), return is made to Act A501 as the state of waiting for the error detection or user input, and the same processing is repeated.

Here, at Act A501, when the user or the serviceman depresses the area 304 representing “shift to next procedure” in the display section 302 used also as the input section in order to know the next procedure (Yes at Act A501), at Act A502, the content selection unit 403 selects new corresponding content, and repeatedly outputs it. At Act A503, the transmission section 404 delivers the content, and clears the elapsed time.

As stated above, when the error detection or the user input is performed before the specified time elapses, the content is kept delivered. When the specified time elapses (Yes at Act A504), at Act A506, the transmission unit 404 stops the transmission of the content.

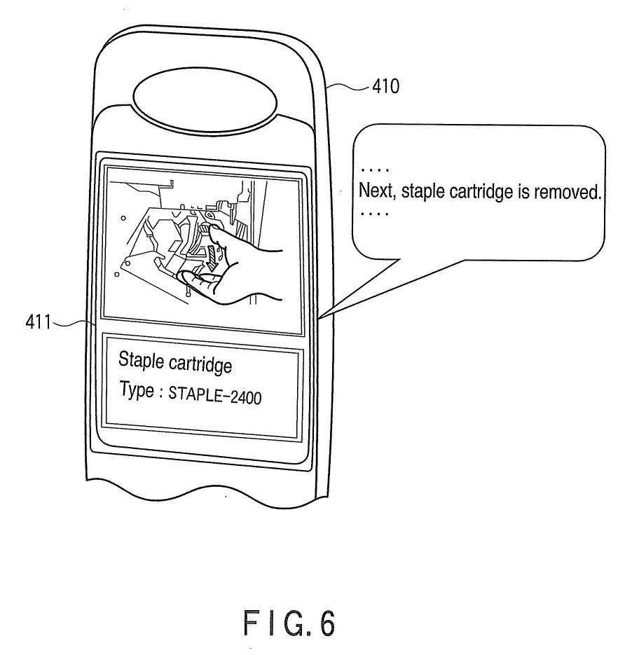

FIG. 6 is a view showing an example of delivered content. This example shows the content delivered when staples of a stapler are depleted. First, the message of “Please supply staples of the stapler” is displayed on the display section 302 of the control panel 301. At the same time as the display, the broadcast wave of the terrestrial digital broadcasting is transmitted. The transmitted content relates to the method of supplying the staples of the stapler, and includes the motion picture and voice guidance to represent the staple supply operation, and text information relating to a replacement part.

The motion picture to represent the supply operation of the staples is displayed on the upper part of a display section 411 of the one-seg broadcasting reception terminal 410, and in synchronization with the scene of the motion picture, the voice information of “Next, the staple cartridge is removed.” is outputted from a speaker, and the text information of “staple cartridge type name: STAPLE-2400” as the replacement part is displayed on the lower part of the display section 411.

As stated above, the user can inexpensively obtain the plain guidance information by the motion picture, voice guidance, and text information. Incidentally, the content can be constructed to include at least one of the voice information and text information in addition to the motion picture information.

### Second Embodiment

Next, a second embodiment of the invention will be described.

This embodiment is a modified example of the first embodiment, and its basic system structure is the same. Hereinafter, the same portions as those explained in the first embodiment are denoted by the same reference numerals and their explanation will be omitted.

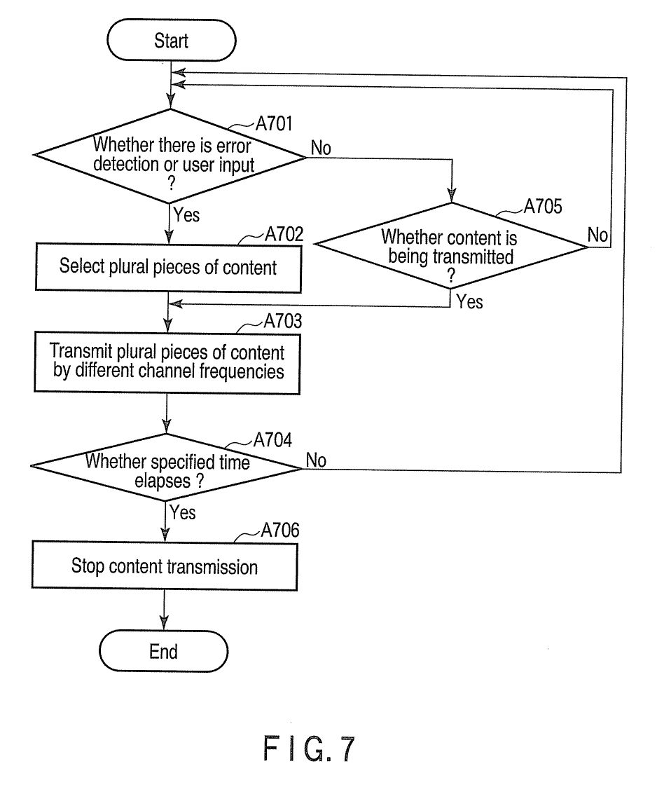

In this embodiment, for a processing operation of the same error, plural pieces of content, such as content for explaining the details and content for explaining only the outline, are previously stored in a content storage unit 402, and content corresponding to the knowledge of a user or a serviceman about an MFP 201 can be provided. FIG. 7 is a flowchart showing a rough procedure of delivering guidance information according to the second embodiment.

At Act A701, when the occurrence of an error or the depression of a help button 303a by the user is detected (Yes at Act A701), at Act A702, a content selection unit 403 selects plural pieces of corresponding content from the content stored in the content storage unit 402, converts them into video signals and repeatedly outputs them.

A transmission unit 404 assigns different channel frequencies to the respective video signals, converts them into broadcast waves of the terrestrial digital broadcasting, and delivers the content from a transmission antenna 405 (A703). By this, the user or the serviceman can select the detailed guide of the processing operation or the simple guide as the need arises.

### Third Embodiment

Next, a third embodiment of the invention will be described.

This embodiment is a modified example of the first embodiment, and its basic system structure is the same. Hereinafter, the same portions as those already explained in the first embodiment are denoted by the same reference numerals and their explanation will be omitted.

This embodiment is not limited to a processing operation of an error, but relates to a method of providing information in a case where some event occurs. In this embodiment, the delivery of required content is performed in response to an operation of a user or a serviceman.

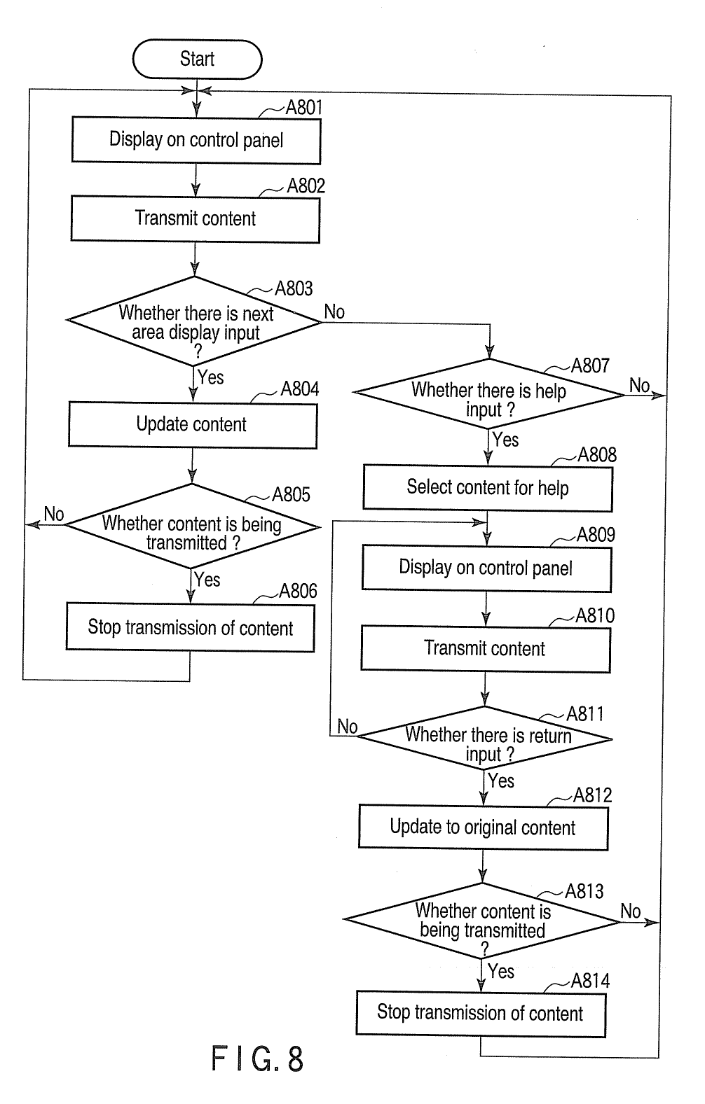

FIG. 8 is a flowchart showing a rough procedure of delivering guidance information according to the third embodiment.

When a specified event occurs, at Act A801, a content selection unit 403 selects corresponding content from content stored in a content storage unit 402, and displays it on a control panel 301. At Act A802, the content selection unit 403 converts the content of motion picture, voice, text and the like into a video signal and repeatedly outputs it through a transmission unit 404.

At Act A803, in order to know a next procedure, when the user or the serviceman depresses an area 304 representing “shift to next procedure” in a display section 302 used also as an input section (Yes at Act A803), at Act A804, the content selection unit 403 selects new corresponding content. At Act A805, when the content is being transmitted (Yes at Act A805), at Act A806, the transmission section 404 stops the delivery of the content being transmitted. Then, return is made to Act A801, and the foregoing operation is performed on the newly selected content.

At Act A807, in order to confirm the details of the displayed content or in order to know what operation is to be performed, when the user or the serviceman depresses a help button 303a (Yes at Act A807), at Act A808, the content selection unit 403 selects new corresponding content for help. At Act A809, the new content for help is displayed on the control panel 301. At Act A810, the content selection unit 403 converts the content of motion picture, voice, text and the like into a video signal, and repeatedly outputs it through the transmission unit 404.

The display and transmission operation of the content for help is repeated and continued until an area (not shown) representing “return” in the display section 302 used also as the input section is depressed (No at Act A811).

When the area (not shown) representing “return” in the display section 302 is depressed (Yes at Act A811), at Act A812, the content selection unit 403 selects the content displayed and transmitted when the help button 303a is depressed. At Act A813, when the content is being transmitted (Yes at Act A813), at Act A814, the transmission section 404 stops the delivery of the content being transmitted. Then, return is made to Act A801, and the foregoing operation is performed on the newly selected content.

Incidentally, in third embodiment, although the delivery of the content is repeatedly continued and is performed, the delivery may be stopped after a specified time elapses similarly to the first and the second embodiments.

In the respective embodiments, the content delivery unit 401 may be attachably and detachably provided to the MFP 201. For example, when the serviceman visits the site for maintenance, where the MFP 201 is installed, the content delivery unit 401 is mounted to the MFP 201 to perform the operation, and is detached after the end of the operation. In this way, the efficiency of the operation can be improved.

According to the respective embodiments described above, various effects are obtained.

At the time of occurrence of an event such as a trouble, the guidance using the motion picture, voice and text of the processing procedure corresponding to the event and replacement part information can be transmitted by radio wave to the receiver or the like carried by the user or the serviceman.

Since the user or the serviceman can perform the processing of the event in accordance with the received guidance using the motion picture, voice and text, the processing method is easily understood and stress is reduced, and further, the downtime taken to return from the occurrence of trouble can be shortened.

In addition, since it is not necessary to install a large display section for displaying a detailed image or a speaker for voice guidance, the cost of the main body can be reduced.

When performing the trouble shooting operation, the user or the serviceman is not required to change the posture to face the control panel each time, and therefore, the operation efficiency is improved.

Although the invention is described in detail by using the specific embodiments, it would be obvious for one of ordinary skill in the art that various modifications and improvements can be made without departing from the split and the scope of the invention. Besides, the signal format, the modulation system and the like of the terrestrial digital broadcasting conform to standards applied in a country, region or the like where the broadcasting apparatus is installed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus, comprising:
a state determination unit configured to determine a state of a machine body;
an input determination unit configured to receive an operation of a user; and
a content delivery unit configured to perform content delivery using a transmission system of terrestrial digital broadcasting based on a request signal from the state determination unit or the input determination unit.

2. The apparatus according to claim 1, wherein a radio wave broadcasted from the content delivery unit is a weak radio wave having a radio field intensity not larger than a specified value.

3. The apparatus according to claim 1, wherein the content broadcasted by the content delivery unit includes at least one of voice information and text information in addition to motion picture information.

4. The apparatus according to claim 1, wherein the content delivery unit includes
a content storage unit configured to store plural pieces of content,
a content selection unit configured to select corresponding content from the content storage unit based on the request signal from the state determination unit or the input determination unit and to output it as a video signal, and
a transmission unit configured to convert the video signal into a broadcast wave of the terrestrial digital broadcasting and to transmit it, and
wherein the content selection unit repeatedly outputs the selected content.

5. The apparatus according to claim 4, wherein the content selection unit repeatedly outputs the selected content for a specified time.

6. The apparatus according to claim 3, wherein the content delivery unit is attachable and detachable.

7. The apparatus according to claim 3, wherein the request signal from the input determination unit is a signal to request information representing a next procedure of the transmitted content or more detailed information of the content.

8. The apparatus according to claim 1, wherein the content delivery unit includes
a content storage unit configured to store plural pieces of content,
a content selection unit configured to select plural pieces of corresponding content from the content storage unit based on the request signal from the state determination unit or the input determination unit and to output them as video signals, and
a transmission unit configured to convert the plural video signals into broadcast waves of plural channels of the terrestrial digital broadcasting and to transmit them, and
wherein the content selection unit repeatedly outputs the selected content.

9. The apparatus according to claim 8, wherein the content selection unit repeatedly outputs the selected content for a specified time.

10. An image forming method comprising:
determining a state of a machine body by a state determination unit;
receiving an operation of a user by an input determination unit; and
performing content delivery using a transmission system of terrestrial digital broadcasting by a content delivery unit based on a request signal from the state determination unit or the input determination unit.

11. The method according to claim 10, wherein a radio wave broadcasted from the content delivery unit is a weak radio wave having a radio field intensity not larger than a specified value.

12. The method according to claim 10, wherein the content broadcasted by the content delivery unit includes at least one of voice information and text information in addition to motion picture information.

13. The method according to claim 10, wherein the performing content delivery includes:
storing plural pieces of content by a content storage unit,
selecting corresponding content from the content storage unit based on the request signal from the state determination unit or the input determination unit and repeatedly outputting the selected content as a video signal by a content selection unit, and
converting the video signal into a broadcast wave of the terrestrial digital broadcasting and transmitting it by a transmission unit.

14. The method according to claim 13, wherein the content selection unit repeatedly outputs the selected content for a specified time.

15. The method according to claim 12, wherein the content delivery unit is attachable and detachable.

16. The method according to claim 12, wherein the request signal from the input determination unit is a signal to request information representing a next procedure of the transmitted content or more detailed information of the content.

17. The method according to claim 10, wherein the performing content delivery includes:
storing plural pieces of content by a content storage unit,
selecting plural pieces of corresponding content from the content storage unit based on the request signal from the state determination unit or the input determination unit and repeatedly outputting the selected content as video signals by a content selection unit, and
converting the plural video signals into broadcast waves of plural channels of the terrestrial digital broadcasting and transmitting them by a transmission unit.

18. The method according to claim 17, wherein the content selection unit repeatedly outputs the selected content for a specified time.
